(19) United States
(12) Patent Application Publication
(10) Pub. No.: US 2015/0106268 A1
(43) Pub. Date: Apr. 16, 2015

(54) METHOD FOR AUTHENTICATING A TRANSACTION

(71) Applicant: VALIDSOFT UK LIMITED, London (GB)

(72) Inventors: Patrick Carroll, London (GB); Jonathan Mark Alford, London (GB); John Petersen, London (GB)

(21) Appl. No.: 14/384,450

(22) PCT Filed: Mar. 13, 2013
(86) PCT No.: PCT/GB2013/050611

§ 371 Date: Sep. 11, 2014

(30) Foreign Application Priority Data
Mar. 13, 2012 (GB) 1204398.0

(51) Int. Cl. G06Q 20/42; H04W 64/00; G06Q 20/32

(52) U.S. Cl. CPC G06Q 20/425; G06Q 20/3224; H04W 64/00
USPC 705/44

(57) ABSTRACT

A method of authenticating a transaction comprises receiving from a user's mobile device user location information and associated network data in response to a change of location or network of the mobile device, storing the location information and (optionally) the network data in a database in a record associated with the user, receiving a request for authentication of a transaction purportedly by the user, the request including transaction location information, comparing the transaction location information and (optionally) the network data to the stored user location information associated with the user, and generating authentication data in response to the result of the comparison.

### FIELD OF THE INVENTION

This invention relates a method of authenticating a transaction, and in particular to determining the validity of a requested transaction and to false-positive prevention such as card present false-positive prevention. More particularly, this invention relates to financial transactions and to card-present false-positive prevention as well as to cross-border card present false-positive prevention.

### BACKGROUND OF THE INVENTION

A false-positive event occurs when a user attempts to carry out a legitimate financial transaction which is declined because the financial provider (for example an issuing bank providing customers with a debit card or credit card) has incorrectly identified that transaction as being potentially fraudulent. The transaction may be a cross-border card-present transaction. A cross-border transaction may be one in which the transaction occurs in a different region to the region where the user is registered with the financial provider. For example, a cross-border card-present transaction could be one where a user withdraws cash from an ATM (automated teller machine) using his credit or debit card abroad or one where a user purchases goods at a Point-of-Sale (PoS) terminal using his credit or debit card abroad. In both cases, the card must be physically present at the point of the transaction e.g. at the ATM or PoS. This is in contrast to a card-not-present transaction where the details of the card are present, for example the name of the card holder, the card number, expiry date, as well as security information. However, the card itself is not present at the location where the transaction is carried out. A card-not-present transaction may occur as a result of an internet or mail order transaction.

Cross-border card-present fraud is on the increase and now accounts for 40% of all card crime on UK issued cards. Chip and PIN (personal identification number) technology allows payment using debit or credit cards. Instead of using a signature to verify payments, the card user must enter a PIN number known only to the card holder. However, technology such as Chip and PIN is ineffective at preventing cross-border card-present fraud as skimmed (counterfeit) cards are simply used at ATMs and PoS devices in countries that do not support Chip and PIN, such as the US, when verification reverts to the card's magnetic stripe rather than the imbedded microchip. Magnetic stripes and the information contained therein are relatively easy to clone, compared to the microchips. Similarly, cloned US cards for instance can be used in the UK as an ATM will recognise a US card and revert to magnetic strip processing.

Banks and other financial service providers generally attempt to prevent card-present fraud through the use of third party software risk engines or in-house logic within the real-time authorisation process in an attempt to determine whether a transaction is likely to be fraudulent. Others will decline all cross-border transactions unless the cardholder has previously supplied the financial service provider with an accurate travel itinerary, which may still prove insufficient. The main problem with the risk-engine approach is that risk engines are highly inaccurate in determining potentially fraudulent transactions. False-positive rates arising from such risk engines are extremely high, typically between 80% and 90%, resulting in substantial inconvenience and cost for the cardholders and banks alike. By false-positive rate, we mean the percentage of incorrectly declined transactions within the total number of declined transactions. Due to the high volumes and costs currently associated with determining false-positives, financial service providers cannot typically decline all of the transactions they would like to, resulting in fraudulent transactions being authorised. This arises when the cost of prevention exceeds the cost of fraud. The main costs to the financial service provider and the customer are incurred in the resolution process of a false-positive transaction.

Therefore, there is a problem that financial service providers often incorrectly identify and decline genuine transactions as potentially fraudulent, particularly when the transactions are carried out in an overseas country, which is not the country in which the card was issued, by the legitimate cardholder.

As a result, because the financial service provider has declined the transaction, it usually contacts the cardholder to confirm whether the transaction was actually fraudulent. This is done either manually by fraud centre operators, which is very expensive, or electronically by outbound dialing services, which are also expensive and may still require manual intervention. In many cases, however, because of the time taken for the financial service provider to instigate this process, the cardholder contacts the financial service provider directly (from abroad) to attempt to resolve the issue. This is far from satisfactory because the cost of telephoning the financial service provider from abroad may be prohibitively high, as is also the case with receiving a mobile call abroad, where the roaming call costs are paid by the recipient. Furthermore, the difference in time zone between countries may mean that the card holder is unable to contact the financial service provider if it is out of working hours in the country where the card was issued.

Our co-pending International Patent Application WO 2010/086608 A2, published on 5 Aug. 2010, the contents of which are hereby incorporated in their entirety, describes one solution to this problem. This application describes a “Just-in-Time solution”, whereby mobile network traffic data such as Home Location Register (HLR) data or Visitor Location Register (VLR) data is accessed when an authentication server receives details of a card-present transaction.

This solution relies on the mobile telephone being operational at the moment of lookup and may also have response time implications, as the accessing of the network data may involve data requests travelling around the world to different mobile network operators.

This is in effect a transient data model, where an external network lookup is performed for every transaction request. The system utilises only network-resident data such as Home Location Register or Visitor Location Register Data (HLR/VLR) and requires no access to the Mobile Station (MS), i.e. the mobile handset.

### SUMMARY OF THE INVENTION

The present invention relates to a method of authenticating a transaction. The method comprises: receiving from a user's mobile device user location information in response to a change of location of the mobile device; storing the location information in a database in a record associated with the user; receiving a request for authentication of a transaction purportedly by the user, the request including transaction location information; comparing the transaction location information to the stored user location information associated with the user; and generating authentication data in response to the result of the comparison.

Thus, according to the invention, the database is updated continually by the users mobile device with the current location and optionally associated network data of the user. When a transaction request is received the location of the transaction can be compared with the stored location and/or network data of the user in order to determine the probability of the transaction being fraudulent. In this way, the potential authenticity of the transaction can be assessed based on the potential location of the user at the time the transaction is requested without the need to query a Home Location Register or Visitor Location Register. This increases the potential speed at which transactions can be authenticated.

The user location information may comprise an indication of the country in which the user is located. The user location information may comprise more specific geographical information, such as the state or region in which the user is located. The user location in formation need not be geographically specific. For example, the user location information may include network data for the telecommunications network to which the user's mobile device is connected. The network data may include an indication of the country or other geographical area serviced by the network. Thus, the change of location may be a change of network.

Typically, the change of location is a change of country. Thus, the user location information or network data may indicate the country in which the user's mobile device is located. Indeed, the user location information may indicate only the country, rather than more detailed location information. Similarly, the transaction location information may indicate the country in which the transaction is to take place. The transaction location information may indicate only the country, rather than more detailed location information.

The database may be any suitable information store, from which the location information may be retrieved as necessary.

The step of comparing the transaction location information to the stored user location information associated with the user may comprise comparing the country in which the user's mobile device is located according to the stored user location information to the country in which the transaction is to take place according to the transaction location information. The method may require an exact match in the countries. Alternatively, the comparison may require only that the transaction location information and the user location information both indicate a country that is different to a user's home country.

The authentication data is data which can be used in authenticating the transaction. Typically, the authentication data comprises an indication of the likelihood that the transaction is fraudulent.

The request for authentication may originate with a point of sale terminal or an automated teller machine. The transaction location information may relate to the location, for example the country, of the point of sale terminal or automated teller machine. The request for authentication may be received from the point of sale terminal or automated teller machine via an authorisation server. For example, a point of sale terminal or an automated teller machine may request authorisation for the transaction from the authorisation server. The authorisation server may request authentication of the transaction in response to receipt of the authorisation request and include the transaction location information in the authentication request. The transaction location information may originate with the point of sale terminal or automated teller machine, for example the transaction location information may be included in the authorisation request. Alternatively, the transaction location information may be included in the authentication request by the authorisation, for example when the authorisation server determines the location of the point of sale terminal or automated teller machine from information identifying point of sale terminal or automated teller machine in the authorisation request. The generated authentication data may be communicated to the authorisation server.

The invention extends to a computer server configured to carry out the method of the invention and to computer software which configures one or more general-purpose computing devices to operate as such a computer server. The invention also extends to a mobile telecommunications device configured to communicate with such a server by sending to the server user location information in response to a change in location of the mobile device. The device may be associated with a home country or a home network and the device may be configured to send user location information to the server only when the device is located outside the home country or the home network. The mobile communication device may be a cellphone, mobile telephone, smartphone, PDA, computing device, tablet or the like.

The invention also extends to computer software which configures a mobile telecommunications device to operate as a mobile telecommunications device in accordance with the invention. The computer software may be a SIM or operating system resident application on a mobile device which monitors changes to dynamic location information stored on the SIM, such as so-called Location Area Identity (LAI) information, or monitors and receives events when the network state has changed. By monitoring changes to the location and network information, embodiments of the invention are able to easily update a remote store of location and network information associated with an identifier of a mobile device, thereby allowing embodiments of the invention to more accurately determine the authenticity of a transaction, and hence assist with whether or not to allow the transaction.

An authentication system for carrying out the invention may comprise: a server arranged to receive location data and associated identification data from a mobile communication device; and a storage means coupled to the server for storing the received location data and identification data. The server may receive the location data and identification data from an application stored on an identifier module of the mobile communication device, wherein the application monitors changes to the location data stored on the identifier module and sends to the server updated location data retrieved from the identifier module in response to the change of location data.

The identifier module may be a removable identifier module, for example a SIM or R-USIM or USIM module. The location information may be Location Area Identity information. The Location Area identity information may comprise one or more of Mobile Country Code Information, Mobile network Code Information, or Location Area Code information. The network information may comprise one or more of Network Name, Network Identifier, Network Cell Identifier, Roaming Status. The application may compare home location information and network data stored on the identifier card with the location and network data stored on the identifier card. The identifier module may store current location information and previous location information. The application may determine whether the current location information is different to the previous location information. The application may only send location data to the server if the home location information is different to the current location data. The server may determine whether the received location information is different to the home location information. The server may delete the location information and identification information from the storage means if the server determines that the current location information of the mobile communication device corresponds to the home location of the mobile communication device. The identification information may comprise one of more of a telephone number, SIM identifier, mobile device identifier associated with a mobile communication device. The server may be arranged to receive data identifying a region where a transaction is being requested. The server may be arranged to receive data identifying a mobile communication device associated with a user requesting the transaction. The server may search the storage means for data matching the received data identifying the mobile communication device. The server may be arranged to determine the location information of the data which matches the received data identifying the mobile communication device. If the server determines that the database comprises data matching the received data identifying the mobile communication device then the transaction may be declined.

### DETAILED DESCRIPTION OF PREFERRED EMBODIMENTS

An embodiment of the invention will now be described, by way of example only, with reference to the accompanying drawings in which:

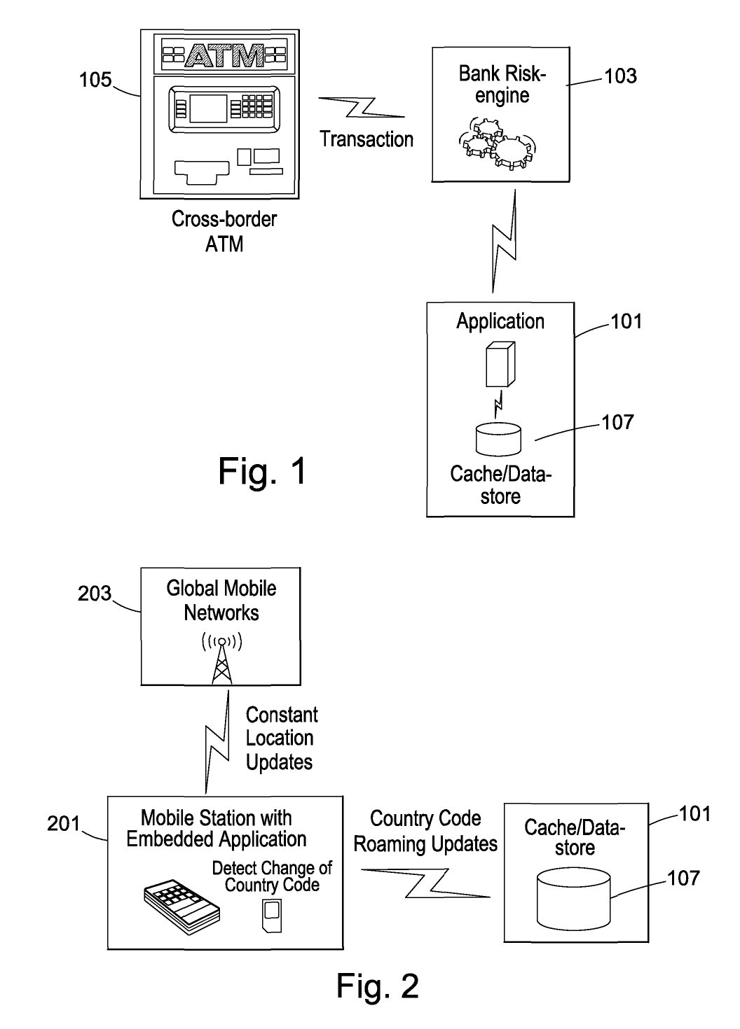

FIG. 1 shows a schematic diagram of the system architecture of an embodiment of the invention;

FIG. 2 shows a schematic diagram of the system architecture of a further embodiment; and

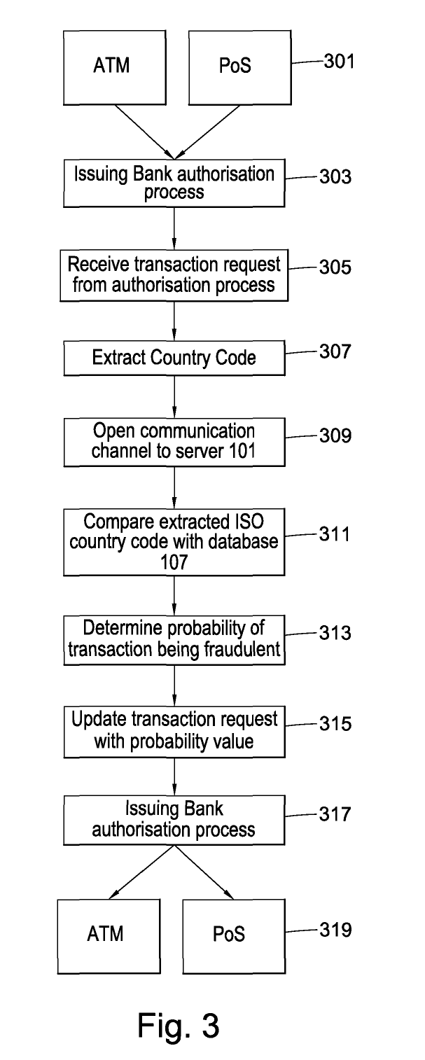

FIG. 3 shows a flow diagram showing the main steps performed by an embodiment of the invention.

Referring to FIG. 1, an example authentication system comprises a financial services provider server or risk engine 103. The server or risk engine 103 determines whether a transaction is likely to be fraudulent or not, based on variables, strategies and various data sources. The risk engine or server 103 may be provided by a bank or other financial institution. The system further comprises a server or computer 101 and an Automated Teller Machine (ATM), Point of Sale (PoS) terminal or other means for performing a transaction 105. The server or computer 101 assists the server or risk engine 103 in determining whether a transaction is likely to be fraudulent or not.

The means for performing a transaction 105 is capable of data communication with the financial services provider risk engine 103. The connection between the transaction performing means 105 and the financial services provider risk engine may be a wireless connection. However, a wired connection or fibre connection or other connection may be used. The financial services provider risk engine 103 is capable of data communication with the computer or server 101, usually wirelessly although once again a wired connection or fibre connection or other connection may be used. The server 101 comprises a database 107 of information of mobile communication devices associated with users authorised to carry out transactions. The database will be described in further detail referring to FIG. 2 of the drawings. Usually, the database 107 is stored on one or more hard disks, although other storage media may be used, such as re-writable CD-ROM or DVD, or solid state memory.

Referring now to FIG. 2, the authentication system comprises a mobile communication device 201, and one or more mobile networks 203. The embodiment shown in FIG. 2 comprises a computer or server 101, also shown in FIG. 1, as well as the database 107 also shown in FIG. 1. The mobile communication device 201 is capable of data communication with the server 101. The mobile networks 203 are also in data communication with the mobile communications devices in a manner known to the skilled person, for example using a second, third or fourth generation mobile telephone network.

The mobile communication device 201 comprises an application, usually a software application, stored on the operating system of a mobile telephone or on the SIM (Subscriber Identity Module) of a mobile telephone. More particularly, the application may reside or may be stored on a Subscriber Identity Module (SIM), or on a virtual SIM, or on a Removable User Identity Module (R-UIM) for Code Division Multiple Access (CDMA) telephones or on a Universal

Subscriber Identity Module (U-SIM) for Universal Mobile Telecommunications System (UMTS) telephones. Each of these modules or cards also temporarily stores network location information, and this will be described in further detail below. The software application may also be an application (or “app”) of the kind commonly downloaded to smartphones or other mobile devices, or the software may be resident as a component of the underlying operating system of the mobile telephone or smartphone itself.

The application may perform the following functions. For example, the application may monitor network location information or network data that may be stored on the cards. As a mobile communication device moves around a network or roams across networks, certain network state information, including data identifying the currently connected network operator is stored on the card. Such data may also be stored in other locations in the operating system, such as a system log, or in the memory of the mobile device. Usually the network location information is also transmitted to the home operator's network, and the local operator's network where cross-network roaming is involved.

In the case of a Global System for Mobile (GSM) SIM, this network state information is referred to as a Location Area Identity (LAI). The LAI is a unique identifier of a particular area of the mobile network. Therefore, the location information may comprise LAI information or the location information may only include LAI information. The LAI may include a Mobile Country Code, a Mobile Network Code, and a Location Area Code.

The software application monitors this network state information for comparison against its home network information. The home network information is stored on the device or removable storage used by the device, as well as being resident in the cache of the running application.

For example, in the case of a GSM SIM, LAI information may be stored on the SIM. The Country Code within the LAI will change as a user travels between countries and connects to a foreign network. If a user has connected to a foreign network, then the Country Code within the LAI is different from the home network Country Code which may be stored in a number of ways, as described above.

Accordingly, the application monitors the LAI information stored on the SIM (or elsewhere). If, as a result of moving around the network, the mobile communication device writes to the SIM and changes the mobile location and associated network data, then the application notes that the mobile location and associated network data has been changed. For example, the application may register for network events with the operating system of the mobile device. On receipt of a network event from the operating system, the application will compare a value stored by the application for the current country code to the actual value. If the country code has changed, the application will note this change and store the new country code.

In this way, the application detects the change in the mobile location and associated network data and sends the change in location and associated network data to the database 107 stored on the server 101. The application sends the updated location and associated network data to the database 107 in response to the change in location and associated network data. The application may also send the location and associated network data to the database 107 periodically or in response to other events, such as the activation of the mobile device.

Accordingly, the application sends a message, such as a TCP/IP or UDP message to the IP address of the server. This requires a data connection, for example 3G/4G or wireless, to the server 101 containing a data-store or cache 107. The message, at a minimum, comprises data identifying the telephone number (MSISDN) of the SIM being used in a particular mobile device and the new mobile country code for that particular telephone number. The message may also include security information identifying the message as a genuine update from the user's mobile device. In addition, further location and network data may be aggregated to the message should it be required to determine the authenticity of the user, device and transaction.

The server 101 receives the message and creates or updates a record in the database 107 associated with the identification data (e.g. telephone number) corresponding to the user in question showing the new location and network data. If the database already has a record corresponding to the provided identification data, then the server stores the new location and network data in place of the previous location and network data associated with the identification data. The database 107 may maintain the previous location and network data with a time stamp to indicate when the change occurred, in the event that a transaction request arrives in near real-time and it is necessary to compare the country code at the actual time of the transaction.

Where the location and network data reverts back to the “home” location data and “home” network data for the mobile device, the record can be deleted, reflecting that the cardholder is again resident in the card's country of issue.

The main steps carried out by an embodiment of the invention will now be described.

Referring now to FIG. 3, a user first starts a transaction at an ATM or PoS or other means for performing a transaction 105, at step 301. If the transaction is being requested at an ATM, the user inserts a card into the ATM and enters his PIN number. Alternatively, if the transaction is being carried out at a PoS, then the user may physically pass the card to the retailer who inserts the card into a card reader for processing. The user may optionally enter a PIN, if the card is a chip and PIN card. Other verification schemes such as signature may also be used, alternatively or in addition to a PIN. In all cases, the card comprises data associated with an individual or user which allows the user's account to be identified.

The ATM or PoS then contacts the financial service provider (card issuer) at step 303, and the Issuing bank or financial service provider 103 authorisation process starts. In this process, the financial service provider receives a transaction request, at step 305. The ATM or PoS sends information enabling the identity of the card holder to be deduced. This information may comprise the card number (PAN) and may be sent by conventional means or using wireless means known to the skilled person. The information also may be sent in any suitably encrypted form known to the skilled person.

Once the bank or financial service provider 103 has received the transaction request, it may optionally perform additional processing to determine (using software risk engines or in-house logic) whether the transaction is likely to be fraudulent, for example if the transaction is for a large amount. However, if the financial service provider 103 determines that the transaction is likely to be genuine, then it can proceed directly to the authorisation process, at step 317, allowing the transaction at step 319. If the financial service provider determines that the transaction may be fraudulent, then it passes the request to the server, 101.

However, if the financial service provider does not perform this additional processing, then it passes the transaction information directly to the server 101.

At step 307, the financial service provider extracts the ISO country code for the transaction from the transaction information.

In one embodiment, the server 101 may be located within the financial service provider's organisation. However preferred embodiments have a server 101 which is physically separate from the financial service provider, and the transaction information (for example ISO Country Code and Timestamp of transaction) along with the mobile telephone number(s) of the cardholder associated with the card is sent using wireless or conventional wire technology to the server 101. The financial service provider maintains records of the mobile telephone numbers associated with each cardholder in order to be able to supply such information to the server 101. In this case, the records of the database 107 may store the current country code for the users mobile device against the corresponding identifier. The identifier may be communicated to the database 107 by the application on the mobile device at the time the country code is updated in the database 107.

A communication channel to the server 101 is opened at step 309, and the server 101 receives the information identifying the mobile communication device (mobile telephone number(s)) of the customer 109 from the issuing bank. It then searches the database 107 using the previously determined identification data (e.g. telephone numbers(s)) of a communication device associated with a user requesting the transaction.

The server 101 then searches at step 311 the database 107 for the most current location record based on the identification data provided. It then compares at step 311 the ISO country code determined at step 307 with the location information associated with the previously determined most current location record. This includes ensuring that the transaction timestamp is not greater than the end timestamp of the returned record (indicating that the users mobile device is no longer present in that country).

For example, if there is a match on the mobile telephone number and the transaction timestamp is not greater than the end timestamp (if one exists) and the determined country code at step 307 is determined to match the location and/or network data stored in the database 107, then a low probability of the transaction being fraudulent is determined at step 313. In one example, a low probability (for example 0) of a transaction being fraudulent is determined if the location and/or network data determined from the database 107 matches or is identical to the ISO country code determined at step 307. Conversely, a high probability (for example 1) of the transaction being fraudulent may be determined if there is no current entry in the database for the identification data, indicating the cardholder has not left his/her country of mobile registration.

In this way, rather than performing a real-time lookup of network HLRA/LR information, the server 101 compares the transaction ISO country Code determined at step 307 to the cache or data-store 107 which is kept up to date by the application on the mobile device.

Having a dedicated cache or data store 107 of data or information provides a much faster response time. This also does not require the mobile communication device to actually be turned on when the transaction is being carried out, provided of course, that it has been turned on at some stage within the cross-border country.

By providing a dedicated database, embodiments of the invention also have the advantage that look-up costs are reduced as the system does not need to access network data for every cross-border card-present transaction the bank may wish to examine.

In summary, there is disclosed herein a method of authenticating a transaction comprises receiving from a users mobile device user location information and associated network data in response to a change of location or network of the mobile device, storing the location information and (optionally) the network data in a database in a record associated with the user, receiving a request for authentication of a transaction purportedly by the user, the request including transaction location information, comparing the transaction location information and (optionally) the network data to the stored user location information associated with the user, and generating authentication data in response to the result of the comparison.

1. A method of authenticating a transaction at a computer server which is separate from a mobile network, the method comprising:
receiving from a user's mobile device user location information in response to a change of location of the mobile device;
storing the location information in a database in a record associated with the user;
receiving a request for authentication of a transaction purportedly by the user, the request including transaction location information;
comparing the transaction location information to the stored user location information associated with the user; and
generating authentication data in response to the result of the comparison;
wherein the user location information comprises mobile network location information obtained from a mobile network by an application operating on the mobile device and the computer server receives the user location information via a data connection between the mobile device and the computer server in response to the application noting that the mobile network location information has changed.

2. A method as claimed in claim 1, wherein the user location information received from the user's mobile device includes network information for the mobile network to which the mobile device is connected.

3. A method as claimed in claim 1, wherein the change of location is a change of the mobile network to which the mobile device is connected

4. A method as claimed in claim 1, wherein the change of location is a change of country.

5. A method as claimed in claim 1, wherein the user location information indicates the country in which the user's mobile device is located.

6. A method as claimed in claim 1, wherein the transaction location information indicates the country in which the transaction is to take place.

7. A method as claimed in claim 5, wherein the step of comparing the transaction location information to the stored user location information associated with the user comprises comparing the country in which the user's mobile device is located according to the stored user location information to the country in which the transaction is to take place according to the transaction location information.

8. A method as claimed in claim 1, wherein the authentication data comprises an indication of the likelihood that the transaction is fraudulent.

9. A method as claimed in claim 1, wherein the request for authentication originates with a point of sale terminal or an automated teller machine and the transaction location information relates to the location of the point of sale terminal or automated teller machine.

10. A method as claimed in claim 9, wherein the request for authentication is received from the point of sale terminal or automated teller machine via an authorisation server.

11. A method as claimed in claim 10, wherein the generated authentication data is communicated to the authorisation server.

12. A computer server configured to carry out the method of claim 1.

13. Computer software which configures one or more general-purpose computing devices to operate as a computer server as claimed in claim 12.

14. A mobile device configured to carry out the method of claim 17.

15. A mobile device as claimed in claim 14, wherein the mobile device is associated with a home country or a home network and the mobile device is configured to send user location information to the computer server only when the mobile device is located outside the home country or the home network.

16. A software application which configures a general-purpose mobile device to operate as a mobile device as claimed in claim 14.

17. A method of operating a mobile device, the method comprising:
obtaining mobile network location information from a mobile network to which the mobile device is connected;
noting by an application operating on the mobile device that the mobile network location information has changed; and
transmitting user location information comprising the changed mobile network location information to a computer server which is separate from the mobile network via a data connection between the mobile device and the computer server.

18. A software application which configures a general-purpose mobile device to operate as a mobile device as claimed in claim 15.
